(19) United States
(12) Patent Application Publication
(10) Pub. No.: US 2014/0077950 A1
(43) Pub. Date: Mar. 20, 2014

(54) COVER ACCESS NOTIFICATION DEVICE

(71) Applicants: Erick Rudaitis, Sterling Heights, MI (US); Jeffrey John Hanft, Commerce Township, MI (US)

(72) Inventors: Erick Rudaitis, Sterling Heights, MI (US); Jeffrey John Hanft, Commerce Township, MI (US)

(21) Appl. No.: 13/621,565

(22) Filed: Sep. 17, 2012

(51) Int. Cl. G08B 13/08

(52) U.S. Cl. 340/545.6

(57) ABSTRACT

A cover access notification device is employed with a utility meter box having a cover. The device is operable to detect when an impermissible open condition has occurred, for example, if an intruder breaks into a meter box. If a tampered condition is sensed, the device transmits a signal through a smart grid network which can be received by a revenue protection system that in turn monitors tampering of a utility meter.

### FIELD OF THE INVENTION

A security device for use in connection with the utility industry is disclosed, and, more particularly, a notification device and methodology that is operable to detect a utility cover open condition and communicate same to a network.

### BACKGROUND AND BRIEF SUMMARY OF THE INVENTION

Utility theft continues to increase with the depressed state of our economy and due to increasing energy costs to the public and industry. Both residential and commercial utility losses are growing drastically each year, with commercial and industrial losses far outpacing theft occurring in residential settings. It is estimated that losses due to utility theft exceed one billion dollars each year, thus making this a costly problem for utility providers, who in turn, tend to pass these losses on to users of our utilities.

The problem with utility theft is exacerbated by the problem with the reduction in our work force as this has hampered aggressive investigation of reported thefts. A further problem with the reduction of the work force is that there are fewer on-site visits for every meter in the field. With fewer eyes in the field to identify theft and even respond to thefts that have been reported, utility providers are being negatively impacted by these factors.

Existing technologies in the field unfortunately are passive in that they often require workforce in the field in order to investigate utility theft. The investigation often results in a finding that the utility meter box has been broken into via destructive means. Such meter boxes often use passive designs that tend to mechanically lock down the cover of the meter box. Examples of passive designs include gang-socket locking bars, padlocks on meter boxes, and hardened cover locks. These passive locking designs fail to capture evidence of the theft event nor do they notify the utility that a theft has occurred. Another problem with such passive designs is that they fail to provide any intelligence about the length of time in which the meter has been improperly accessed.

It would be desirable to provide an improved notification system and methodology for detecting when a utility device has been tampered with improperly. It would be desirable to provide such a device and methodology that can be retrofit to existing meter boxes without additional tools, without any outside additional power, and that uses a low power wireless chip that makes the device operable to communicate with other systems. One such example could be to provide a security notification device for use in detecting when a cover of a meter box has been tampered with, the security notification device comprising: a housing having a first portion and a second portion; a switch positioned relative to one of these portions; a circuit board located within the housing; and a power supply positioned within the housing. Other examples will become apparent from reading the disclosure below.

### BRIEF DESCRIPTION OF THE DRAWINGS

FIG. 1 illustrates a potential network architecture where the cover access notification device may be employed;

FIG. 2 illustrates a meter box employing a meter that is in communication with the cover access notification device;

FIG. 3 illustrates the front panel of the meter box opened, with the cover access notification device installed relative to the meter box;

FIG. 4 illustrates the deterrent flange of the cover access notification device in place relative to the top panel of the meter box;

FIG. 5A illustrates a partial side view of the front panel of the meter box in the closed position, with the cover access notification device not yet activated;

FIG. 5B illustrates a partial side view of the front panel of the meter box in the closed position, with the cover access notification device in the door closed mode;

FIG. 6 illustrates a partial side view of the meter box, with the front panel opened, showing the plunger of the cover access notification device in its door open mode;

FIG. 7 illustrates a perspective view of the cover access notification device assembly;

FIG. 8 illustrates an exploded view of the FIG. 7 cover access notification device assembly;

FIG. 9 illustrates a perspective view of the FIG. 7 cover access notification device assembly, but this time rotated 90 degrees, and illustrating an adhesive member that could be employed for mounting purposes; and

FIG. 10 illustrates the FIG. 9 cover access notification device assembly, but with the top housing and circuit board assemblies removed, depicting only the bottom housing and its features.

### DETAILED DISCUSSION OF THE PREFERRED EMBODIMENTS

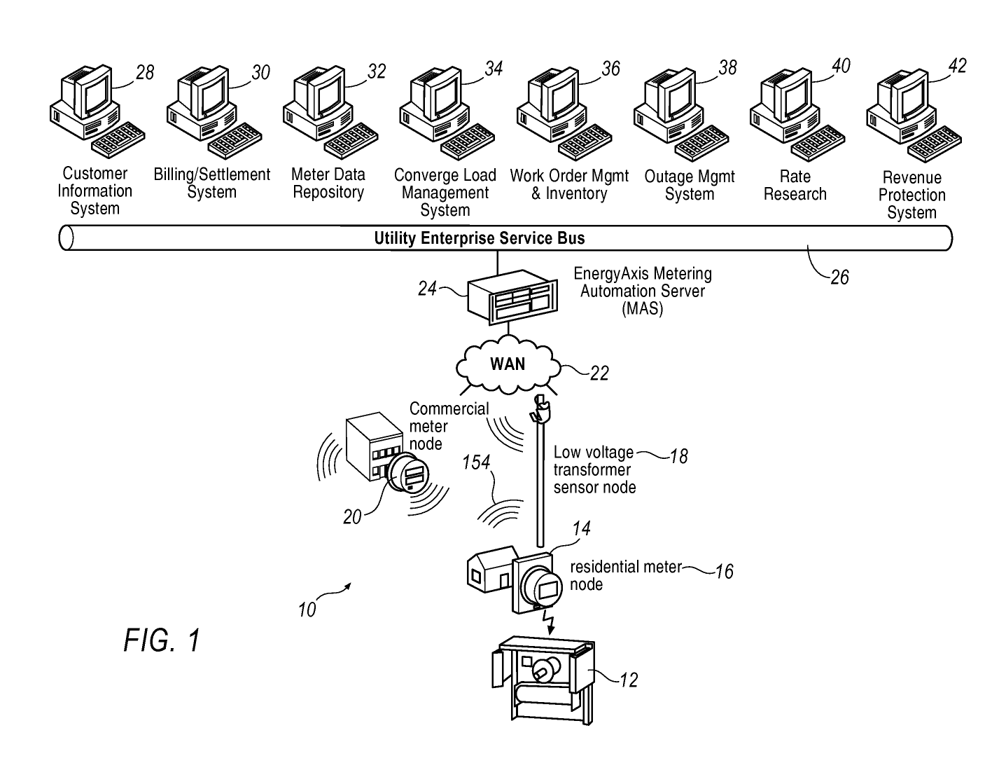

FIG. 1 discloses a smart grid network 10 that employs a novel cover access notification device 12 that can be a component of the network. The network 10 can be utilized in the utility industry for communicating information from the field to various users and systems that may be connected to the network. The cover access notification device 12 can be positioned within a meter box 14 which operates as a residential meter 16 which in turn can communicate wirelessly 154 to a low voltage transformer sensor node 18. It is possible for a commercial meter node 20 to be provided along with the sensor node 18 which in turn communicates upstream to a wide area network or WAN 22. The WAN 22 communicates upstream to an energy axis metering automation server, or MAS 24. A utility enterprise service bus 26 provides open communications to a series of systems that are within the network architecture such as, but not limited to, a customer billing information system 28, a billing/settlement system 30, a meter data repository 32, a converge load management system 34, a work order management and inventory system 36, an outage management system 38, a rate research system 40, and a revenue protection system 42. It will be appreciated that the cover access notification device 12 can be utilized in networks having other architecture. The device 12 in particular can communicate with revenue system 42 so as to provide data such as a break-in event, energy loss, burglar identification, theft profile, and more. The device 12 can be used in other utility applications apart from the specific electric meter application that is disclosed herein.

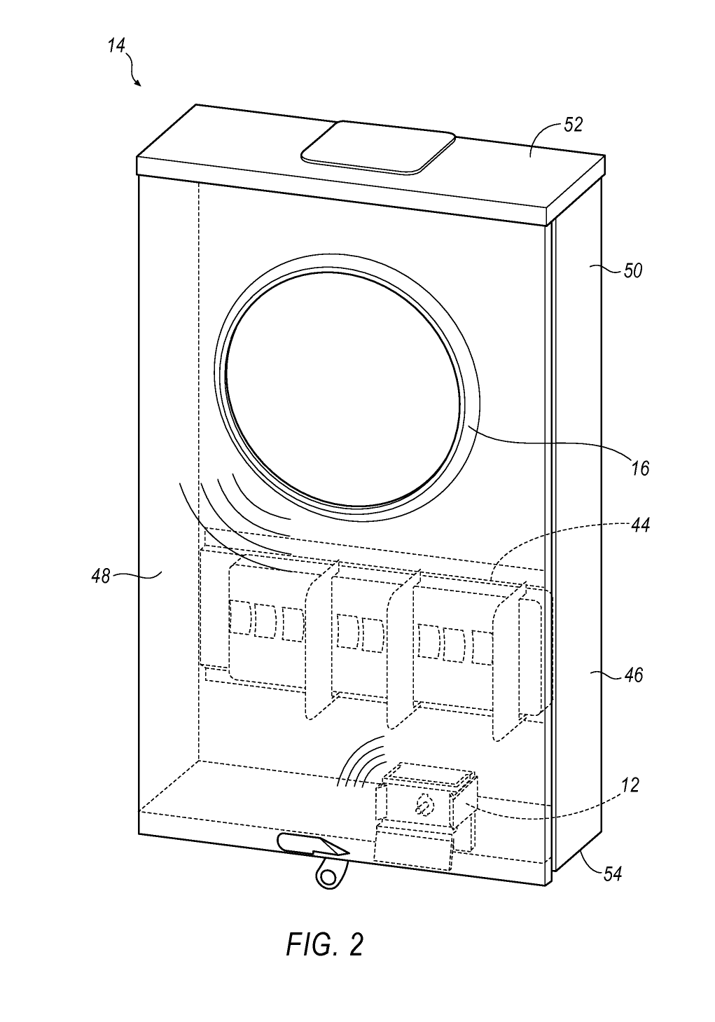

FIG. 2 illustrates a meter box 14, which includes a meter 16, a switch assembly 44, the cover access notification device 12 and a meter housing 46. The switch assembly 44 and cover access notification device 12 are shown in phantom because the cover 48 is shown in a closed position. The meter housing 46 includes sidewalls 50, a top wall 52 and a bottom wall 54.

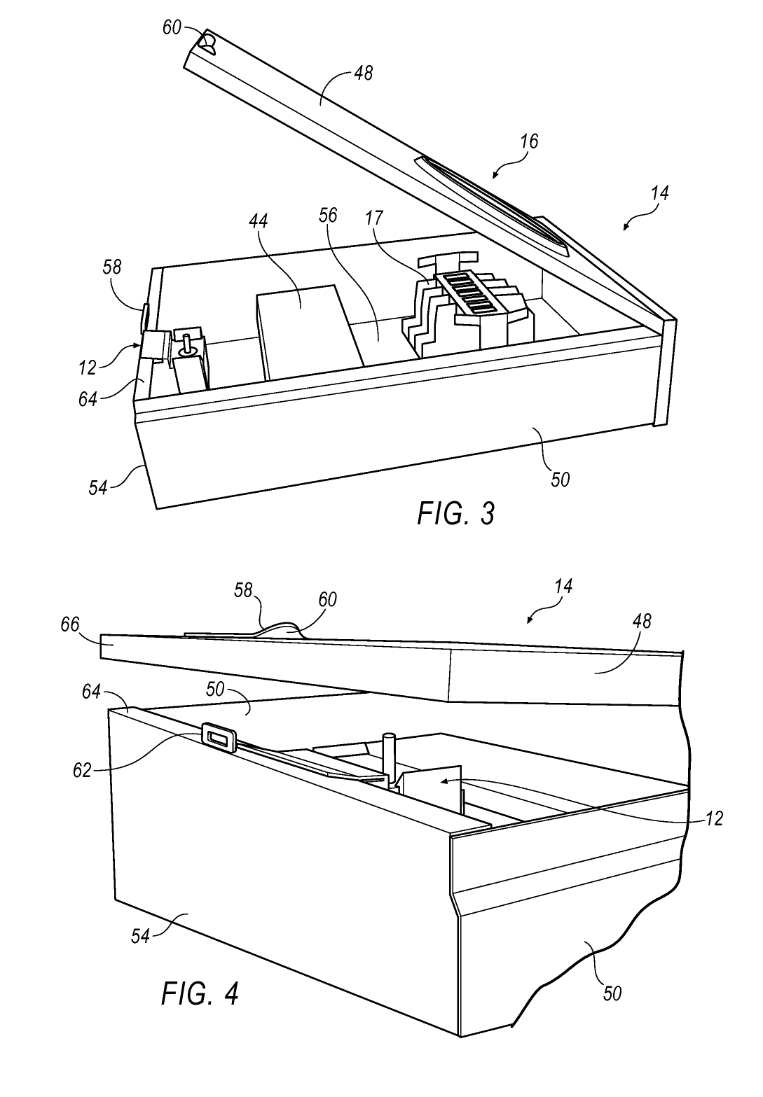

With reference to FIG. 3, the meter box 14 is shown with the cover 48 partially opened so that the interior components of the meter box 14 can be depicted. The residential meter 16 has a meter block 17, which along with the switch assembly 44 are shown mounted to a back wall 56 of the meter box 14. The cover access notification device 12 is shown positioned at a lower position within the meter box 14 and near a latch assembly 58. The latch assembly 58 has a male portion 60 and a female portion 62 (See FIG. 4).

The cover access notification device 12 may be secured by various methods to the back wall 56 of the meter box 14, or to the bottom wall 54 of the meter box. It will be appreciated that the cover access notification device 12 could be positioned at a variety of locations relative to the meter box 14. Because the cover access notification device 12 senses the movement of the cover 48, it will be important that the device 12 be positioned relative to the cover 48 so as to sense certain conditions. For example, one such condition could be the condition of the cover of the meter box 14 being tampered with by an intruder. It will be appreciated that the device 12 could be secured to the meter box 14 by various methodologies, including, but not limited to, through the use of magnets, fasteners, adhesives, brackets, or the like. If magnets are employed, the device 12 could have magnets to be part of the construction of the device 12 which would allow the device 12 to be easily maneuvered and repositioned. Thus, device 12 can be temporary, permanent, and/or removable as well as repositionable. The device 12 is preferably made of durable, weather resistant material, such as metal, plastic, or other desirable material.

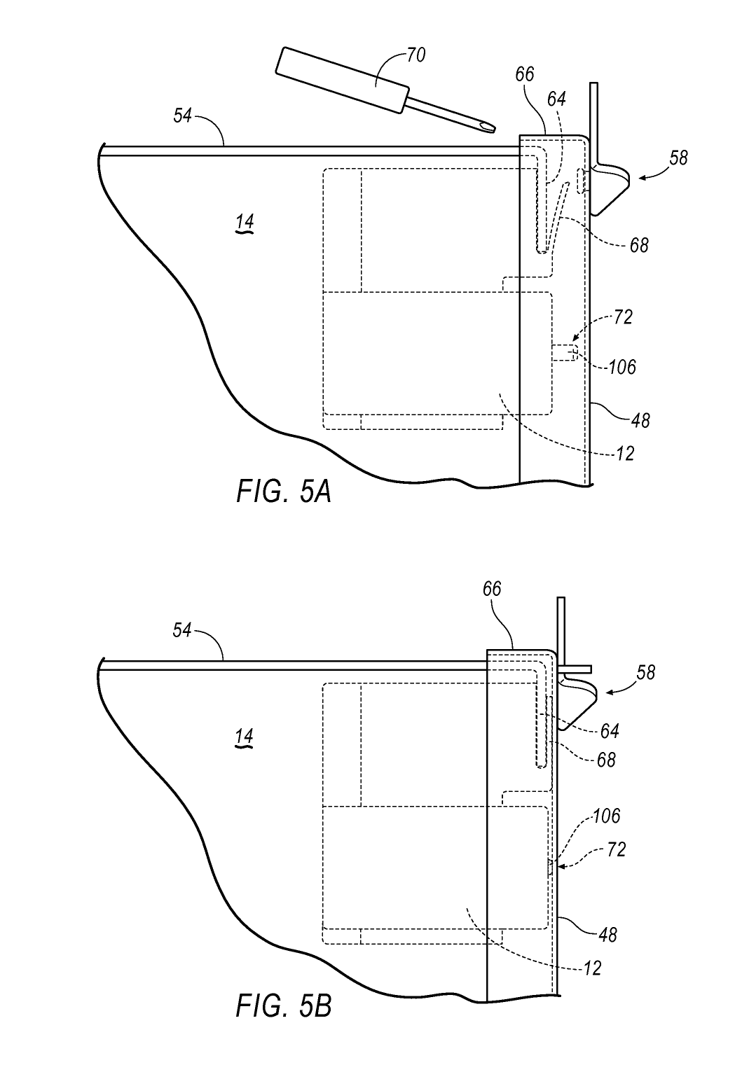

With reference to FIG. 5A, the cover access notification device 12 is shown positioned inside the meter box 14. The bottom wall 54 has a bent over lip 64. Likewise, the cover 48 has a bent over lip 66 that overlaps the bottom wall 54 of the meter box 14 which is generally made of heavy gauge steel. This creates a sealed unit which prevents debris and the environment from negatively impacting the meter box 14. The cover 48 is shown partially closed in an un-locked position and the latch assembly 58 is not yet locked. The plunger 106 of the switch 172 is offset a distance from the back surface of the cover 48, which means the switch as not yet sensed the closed cover condition. The cover access notification device 12 includes a flange 68 that is positioned adjacent lip 64 of the bottom wall 54. The flange 68 is positioned at approximately a 45 degree angle relative to lip 64. The flange 68 acts as a deterrent device to prevent undesirables from penetrating the meter box with a device such as a screwdriver 70. The flange 68 further prevents a screwdriver 70 or other intrusion device, from reaching switch 72 and disarming same. Thus, the flange 68 acts as an intruder deflection device so as to keep undesirables from tampering with switch 72 and potentially disarming same.

FIG. 5B illustrates a meter box assembly 14 with the cover 48 shown in a closed, and locked, condition. The latch assembly 58 is shown in its latched position thus tightly securing the cover 48 to the bottom wall 54. During this closed cover condition, the switch 72 has its plunger 106 shown in a depressed state, which in turn allows the switch 72 to generate a closed cover 48 condition. When the cover 48 is closed as depicted in FIG. 5B, the flange 68 is compressed against the lip 64, thus making it difficult for an intruder to gain access to the switch 72 without a signal being generated indicating a tampering event has occurred.

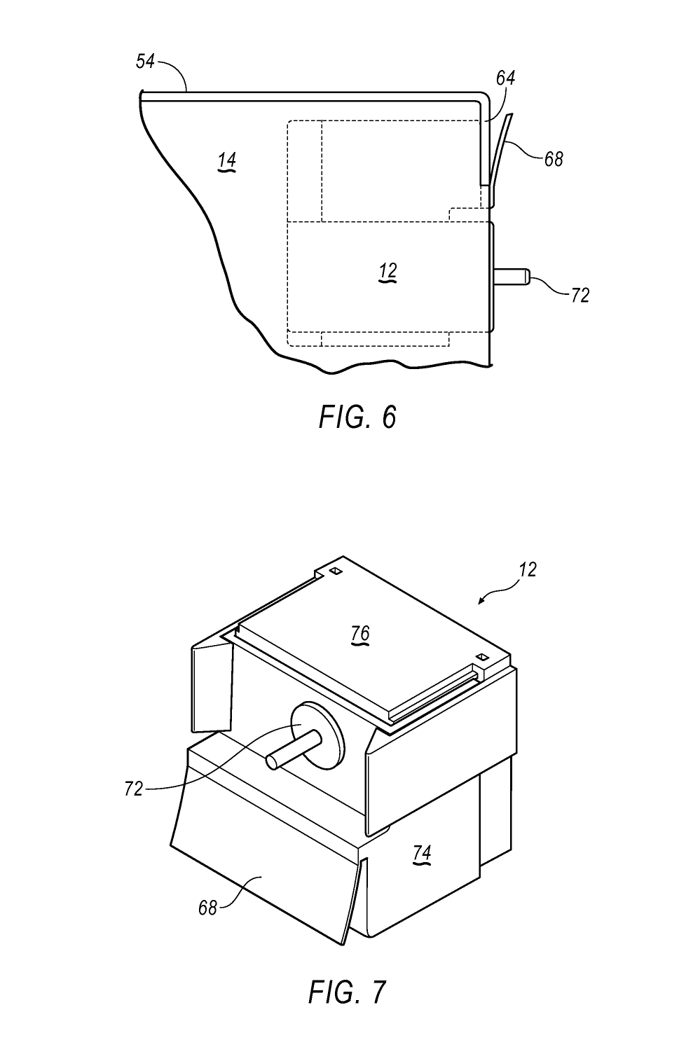

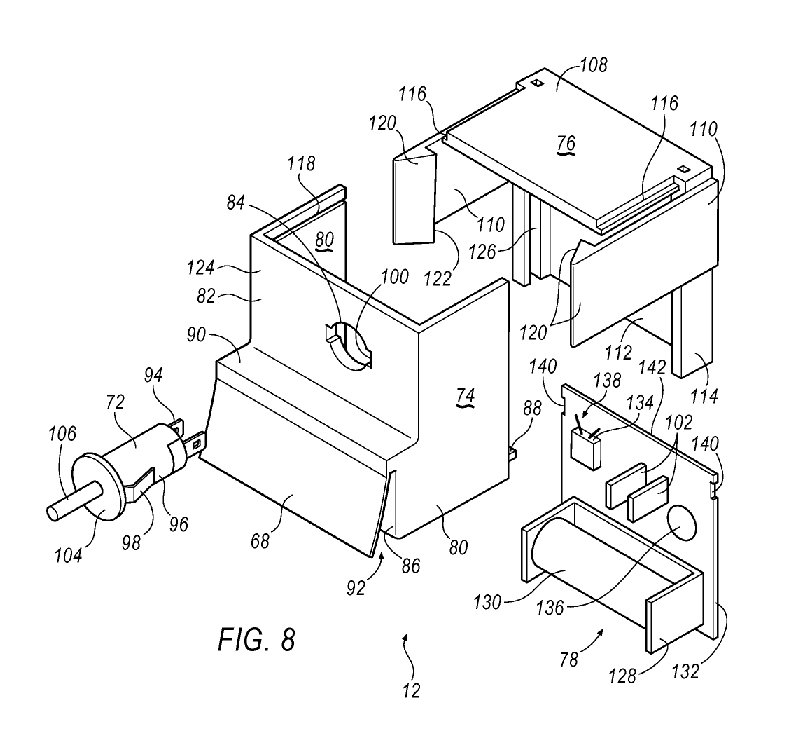

FIG. 6 illustrates the meter box 14 with the cover 48 removed. The switch 72 is shown in a deployed position which means it is producing a signal indicative of the cover 48 being opened. FIG. 7 illustrates a perspective view of the cover access notification device 12 in an assembled condition. FIG. 8 illustrates an exploded view of the device 12. The components of the device 12 include a switch 72, a top housing 74, a bottom housing 76, and a circuit board assembly 78.

The top housing 74 includes a pair of upstanding side walls 80, a first vertical wall 82 with an aperture 84, a second vertical wall 86, and a base 88 and a shelf 90. The flange 68 depends from the shelf 90 at an angle approximately to 45 degrees from the second vertical wall 86. The opening 92 should be sufficient to be able to receive the lip 64 of the bottom wall.

The switch 72 includes a pair of contacts 94 and a body 96 that is operable to be received within aperture 84. A clip 98, secured to the body 96, is received within recess 100 so as to orient the contacts 94 properly relative to terminals 102 on the circuit board assembly 78. The switch 72 further includes a face 104 that is operable to impinge upon the outer surface of first vertical wall 82. The clip 98 further aids in securing the switch 72 in place relative to the top housing 74. The switch 72 further includes a plunger 106 that is operable to move axially relative to the body 96 upon contact by an object. It will be appreciated that the switch is of the type that is operable to generate signals upon a sensed condition, such as when the cover of a meter box has been tampered with by an intruder.

The bottom housing 76 includes a top surface 108, wings 110, a bottom surface 112 and side members 114. The top surface 108 has an L-shaped notch member 116 on both sides of the top surface 108, which runs substantially the entire width of the top surface 108. The notch members 116 are operable to mate with a groove 118 that extends a substantial portion within side wall 80 of the top housing 74. Thus, the top housing 74 and the bottom housing 76 are operable to slide together due to this tight fitting arrangement so as to create a sealed device 12.

Wings 110 each have inwardly depending members 120 that are operable to flex outwardly while the bottom housing 76 is slid inward relative to the top housing 74. Each wing has an inner surface 122 that is operable to engage an outside surface 124 of the first vertical wall 82. Once the wings 110 lock into place relative to the first vertical wall 82, the two housings are then selectively and firmly held together, thus creating a selective locking engagement system.

To disengage the bottom housing 76 from the top housing 74, the consumer may press members 120 to an outward position, which causes the wings 110 to likewise move outwardly. This action frees the bottom housing 76 from the top housing 74 so that they may be slid away from one another. By separating the housings 74 and 76, the consumer will have access to the inside compartment that is formed by the housings. Once the compartment is open, the battery 130 may be changed and other servicing of the circuit board may take place if so desired.

The bottom housing 76 further includes a pair of slots 126 extending a substantial distance of the length of the bottom housing. Each slot 126 is operable to receive the thickness of the circuit board 132, thus allowing the circuit board 132 to slide within and relative to the side members 114. This prevents the board from shifting and creates a locking arrangement for the housing 76 and the circuit board assembly 78.

The circuit board assembly 78 includes a battery holder 128, a power supply 130, a board 132, a computer chip 134, a crystal 136 and the pair of switch connectors or terminals 102. The circuit board could also have a built in antenna 138 making the device 12 operable for communicating wirelessly to a network 10.

The chip 134 is mounted to the circuit board 132 and is preferably a fully integrated chip for ultra-low power wireless communication applications. The chip 134 is preferably IEEE standard 802.15.4 compliant with secure encrypted data flow. The chip may have a wi-fi interface and integrated antenna 138 that is operable to function in a crowded wireless environment. Other characteristics of the chip 134 could include a radio transceiver, an integrated real-time medium access control processor, an integrated microcontroller, a security engine, an event scheduler, an advanced power management feature, memory and an extensive set of peripherals including keyboard scanner and an IR signal generator. It will be appreciated that the chip 134 may have some or all of the above-referenced features, yet may have yet additional features. The chip 134 may have a low battery detection feature which allows detection of the low battery condition and a resulting signal being transmitted informing a user that a low battery condition is present. The circuit is designed such that the circuit draws minimal current when the cover 48 is closed yet begins to draw greater power when the switch 72 senses a cover open condition, or the like.

The circuit board 132 has a pair of notches 140 at opposite sides which aid in locking the circuit board assembly 78 relative to the bottom housing 76. With reference to FIGS. 8 and 10, the circuit board assembly 78 is operable to slide within guide channels or slots 126 of the bottom housing 76. The front edge 142 of the circuit board 132 advances forward within the slot 126 until it reaches a set of tabs 144 that are located at the back end of each of the slots 126. The circuit board 132 advances past the tabs 144 until they are recessed within notches 140. This creates a snap-fit type engagement, thusly securing the circuit board assembly 78 relative to the bottom housing 76. The circuit board may be removed from the housing 76 by pulling the circuit board assembly 78 away from the bottom housing 76. Thus, the circuit board assembly 78 can be rigidly secured to the bottom housing 76, yet it can be removable as well.

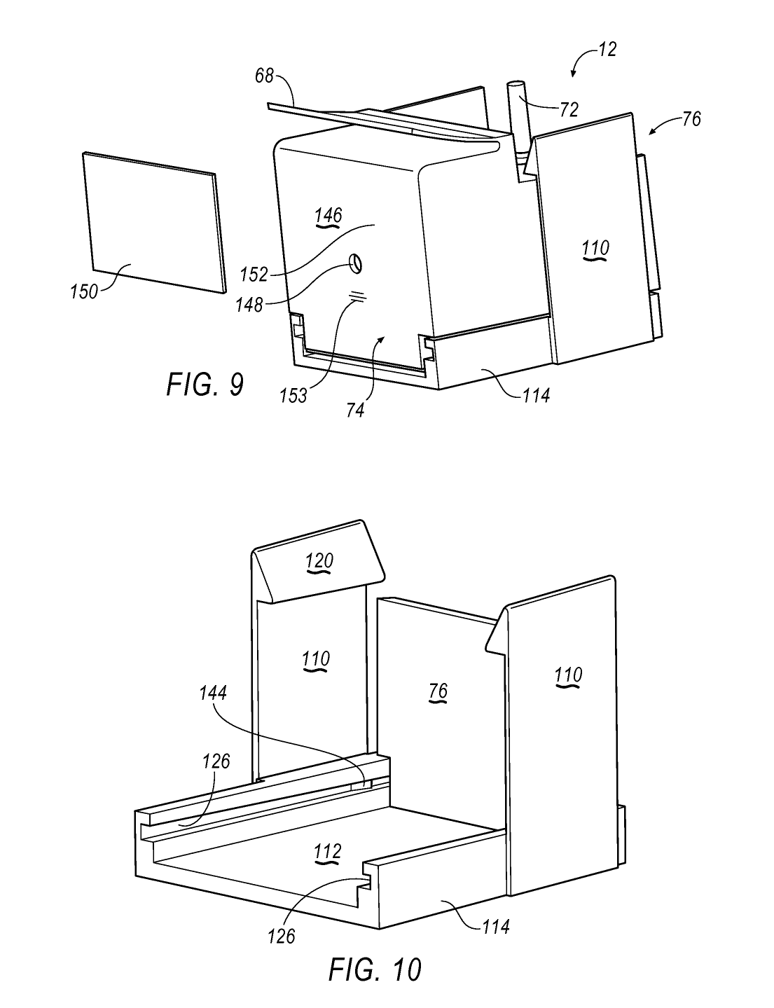

With reference to FIG. 7, the cover access notification device 12 is shown in its assembled condition with the switch 72 ready for deployment. FIG. 9 illustrates the assembled cover access notification device 12 being rotated 90 degrees relative to the embodiment disclosed in FIG. 7. The bottom surface 152 of the top housing 74 could have an aperture 148 where a fastener (not shown) could extend therethrough for attaching the device 12 to a meter box 14. As an alternative arrangement for securing the device 12 to the meter box 14, an adhesive member 150 could be placed on the bottom surface 146 for securing the device 12 to a meter box at a predetermined location. It will be appreciated that the device 12 could have one or more components having a magnetic feature 153 for removably attaching the device 12 to a meter box 14. It will be appreciated that other connecting mechanisms and methodologies may be employed so as to either permanently, or temporarily, secure the device 12 to the meter box 14.

One of the methods of operating a smart grid network 10 utilizing the unique device 12 will now be presented. The device 12 communicates to a residential meter node 16 or a commercial meter node 20 that can be mounted to a meter box 14. A transceiver within the computer chip 134 communicates wirelessly via antenna 138. When the cover 48 of the meter box 14 has been tampered with, or otherwise repositioned, one of four messages 154 can be sent through the smart grid network 10. One such message 154 could be a signal indicating that the cover 48 has been removed, or lifted, or pried open or reinstalled, or that the battery or power supply 130 needs to be replaced. Other messages 154 could be transmitted. This arrangement allows the meter nodes 16 or 20 to communicate to the low voltage transformer sensor node 18 via power line communications, radio frequency signals, or other means. The low voltage transformer sensor node 18 then sends a signal via the WAN 22 to the MAS 24 across the utility enterprise service bus 26, which in turn transmits a signal to the revenue protection system 42, or to other systems such as 28, 30, 32, 34, 36, 38 and/or 40. The revenue protection system 42 is operable to store all communications it receives and generate a data base of prior signals being sent from the device 12. Such data could include, but not be limited to, the aforementioned door open conditions, the location of the device 12, the date and time of the transmission of such signals coming from the device 12, and other desired data that an operator of a network 10 may desire to accumulate, process and/or otherwise observe.

The device 12 is stand alone and operates using its own power supply 130 and requires no outside power. It will be appreciated that the circuit board 132 could have the antenna 138 built within its construct, and thus separate and apart from the computer chip 134.

The mounting of the device 12 is preferably such that the top housing 74 should be positioned within the meter box 14 so that the bottom wall lip 64 is positioned far within the notch that is created by the flange 68 and the second vertical wall 86. The flange 68 presents a barrier or a deterrent from unwanted obstacles such as a screwdriver 70 from being wedged underneath the cover 48. This limits access to the switch 72 so that undesirables do not impermissible tamper with the switch, or the cover of the meter box. But, if the cover 48 is tampered with, the device 12 senses same and notifies the network 10 and those within the network can take measures to address the tamper condition.

It will be appreciated that the aforementioned devices and methods may be modified to have some parts and/or steps removed, or may have additional parts or steps added, all of which are deemed to be within the spirit of the examples herein. Even though the present examples have been described in detail with reference to specific embodiments, it will be appreciated that various modifications and changes can be made to these embodiments without departing from the scope of the examples as set forth in the claims. Accordingly, the specification and the drawings are to be regarded as an illustrative thought instead of merely a restrictive thought of the scope of what is to be protected.

What is claimed as new and desired to be protected by Letters Patent of the United States is:

1. Security notification device for use in detecting when a cover of a meter box has been tampered with, the security notification device comprising:
A housing having a first portion and a second portion;
A switch positionable relative to one of said portions;
A circuit board located within the housing; and
A power supply positioned within the housing.

2. The security notification device as claimed in claim 1, further comprising a meter box, the housing of the security notification device is operable to be secured to said meter box.

3. The security notification device as claimed in claim 1, further comprising a meter box with a meter node, the security notification device is operable to transmit a signal to the meter node to indicate a condition.

4. The security notification device as claimed in claim 1, further comprising a computer chip mounted to the circuit board, the computer chip including a microcontroller, memory, crystal, or an antenna.

5. The security notification device as claimed in claim 1, further comprising a wi-fi interface.

6. The security notification device as claimed in claim 1, further comprising a radio transceiver.

7. The security notification device as claimed in claim 1, further comprising a real-time control processor.

8. The security notification device as claimed in claim 1, further comprising an integrated energy management system.

9. The security notification device as claimed in claim 1, wherein the circuit board includes a connector that is operable to receive said switch.

10. The security notification device as claimed in claim 1, wherein the circuit board includes a notch that is operable to receive a tab that extends from one of the housings, said tab and notch create a lock.

11. The security notification device as claimed in claim 1, wherein the circuit board includes an antenna.

12. The security notification device as claimed in claim 1, wherein the switch includes a member that can be depressed upon impact.

13. The security notification device as claimed in claim 1, wherein the switch includes an alignment member for locating the switch relative to the circuit board in a predetermined position.

14. The security notification device as claimed in claim 1, wherein the housing includes a deterrent member extending from one of said portions, the deterrent member is operable to limit access to the switch.

15. A meter box assembly for an electrical utility application, comprising:
a meter box;
a test switch;
a meter; and
a cover access notification device secured to said meter box, said notification device is operable to detect a tampered condition.

16. The meter box assembly as claimed in claim 15, wherein the access notification device includes a transmitter for sending a signal to the meter.

17. The meter box assembly as claimed in claim 15, wherein the access notification device includes a housing, a sensor, a power source, and a circuit board.

18. The meter box assembly as claimed in claim 15, further comprising a network with a server that has a wireless receiver input, the wireless receiver input is operable to receive signals from the meter box.

19. A method for detecting a tampered condition of an electrical meter box, comprising:
providing a meter box having a cover, a utility meter located relative to the meter box, and a cover access notification device securable to said meter box;
sensing conditions of the cover of the meter box;
sending a signal to the meter once a cover open condition has been detected by the cover access notification device;
gathering data while the cover is in an open state; and
sending a signal to the meter once the cover is in a closed state.

20. The method as claimed in claim 19, further comprising the step of the utility meter sending a signal to a server, the signal being sent to the server is indicative of a condition sensing when the cover of the meter box has been opened.
